(19) United States
(12) Patent Application Publication
(10) Pub. No.: US 2002/0033462 A1
(43) Pub. Date: Mar. 21, 2002

(54) Vacuum exhaust valve

(75) Inventor: Masao Kajitani, Tsukuba-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: SMC Corporation, Minato-ku (JP)

(21) Appl. No.: 09/947,515

(22) Filed: Sep. 7, 2001

(30) Foreign Application Priority Data
Sep. 18, 2000 (JP) 2000-281716

(51) Int. Cl. F16K 31/143

(52) U.S. Cl. 251/63.6; 251/118; 251/335.3

(57) ABSTRACT

In a vacuum exhaust valve in which a valve seat in a flow path connecting a chamber port and a pump port is opened and closed by a valve body, a flow rate adjusting portion in a gradually-tapered shape to be fitted in an inner hole of the valve seat is provided to the valve body in addition to a valve sealing member for opening and closing the valve seat in a poppet manner and the flow rate adjusting portion functions to gradually increase an exhaust flow rate when the valve body opens.

### TECHNICAL FIELD

The present invention relates to a vacuum exhaust valve connected between a vacuum chamber and a vacuum pump and used for gradually reducing pressure in the vacuum chamber to vacuum pressure.

### PRIOR ART

In general, in a manufacturing process and the like of a semiconductor, a vacuum exhaust valve is used for reducing internal pressure of a vacuum chamber to vacuum pressure by a vacuum pump, a semiconductor wafer to be subjected to treatment being disposed in the vacuum chamber. This type of vacuum exhaust valve generally includes a chamber port to be connected to the vacuum chamber, a pump port to be connected to the vacuum pump, a valve seat provided in a flow path connecting the ports, a valve body for opening and closing the valve seat, and a piston for driving the valve body to open and close the valve body and causes the piston to operate by operation of air pressure to open the valve body to thereby exhaust air from the vacuum chamber by the vacuum pump and to reduce the internal pressure of the vacuum chamber to the vacuum pressure.

However, because a prior-art vacuum exhaust valve has a rate characteristic as shown in FIG. 5 and exhausting at an early stage of valve opening rises early and a gradient of the rise is steep, rapid exhausting is carried out at the early stage of exhausting when a large amount of air is still in the vacuum chamber. Therefore, gas turbulence occurs due to temporary flowing of a large amount of air in the vacuum chamber, a cloud of particles deposited on a vacuum chamber inner wall or the like is raised, and the particles may be deposited on a wafer or the wafer moves and a set position of the wafer may be displaced.

### DISCLOSURE OF THE INVENTION

It is an object of the present invention to provide a vacuum exhaust valve in which a valve opening degree is gradually increased in opening of a valve body to make change of a flow rate smooth to thereby prevent occurrence of gas turbulence in a vacuum chamber and to stably carry Gut exhausting.

To achieve the above object, according to the invention, there is provided a vacuum exhaust valve comprising: a chamber port to be connected to a vacuum chamber and a pump port to be connected to a vacuum pump; a casing including the ports; a valve seat in a flow path connecting the chamber port and the pump port; a valve body for opening and closing the valve seat; a piston connected to the valve body through a shaft; a pressure operating chamber for applying air pressure in a valve-opening direction to the piston; and spring means for repulsing the valve body in a valve-closing direction, wherein the valve body includes a valve sealing member for coming in contact with and separating from the valve seat to thereby open and close the valve seat in a poppet manner and a pillar-shaped flow rate adjusting portion to be fitted in an inner hole of the valve seat to move in the inner hole by opening and closing of the valve sealing member and the flow rate adjusting portion is formed in a gradually-tapered shape to thereby have a function of gradually increasing a flow rate of air flowing through the flow path in opening of the valve sealing member.

In the vacuum exhaust valve of the invention having the above structure, because the valve body includes the gradually-tapered pillar-shaped flow rate adjusting portion and the flow rate adjusting portion functions to gradually increase the flow rate of air flowing through the flow path in opening of the valve body, the rise of exhausting at the early stage of valve opening becomes mild. As a result, rapid exhausting is not carried out at the early stage of exhausting when a large amount of air is still in the vacuum chamber. Therefore, turbulence due to temporary flowing of a large amount of air is not generated and it is possible to reliably prevent raising of a cloud of particles deposited on a vacuum chamber inner wall or the like due to the turbulence, deposition of the particles on a wafer, and movement of the wafer or displacement of a set position of the wafer.

According to a concrete embodiment of the invention, the valve body includes a locking portion having a larger diameter than the flow rate adjusting portion in a position extending from the flow rate adjusting portion, a stepped portion with and to which the locking portion is to be fitted and locked is formed in the inner hole of the valve seat, and a valve-closing position of the valve body is defined by the locking portion and the stepped portion.

The flow rate adjusting portion of the valve body has a plurality of tapered faces with different gradients successively in an axial direction or is formed of a smooth curved face in a gradually-tapered shape.

### BRIEF DESCRIPTION OF THE DRAWINGS

FIG. 1 is a sectional view showing a first embodiment of a vacuum exhaust valve of the present invention in a closed state of a valve.

FIG. 2 is a valve body moving amount-exhaust flow rate plot of the vacuum exhaust valve of the invention.

FIG. 3 is a sectional view of an essential portion showing a second embodiment of the vacuum exhaust valve according to the invention in the closed state of the valve.

FIG. 4 is a sectional view of an essential portion showing a third embodiment of the vacuum exhaust valve according to the invention in the closed state of the valve.

FIG. 5 is a valve body moving amount-exhaust flow rate plot of a prior-art vacuum exhaust valve.

### DETAILED DESCRIPTION

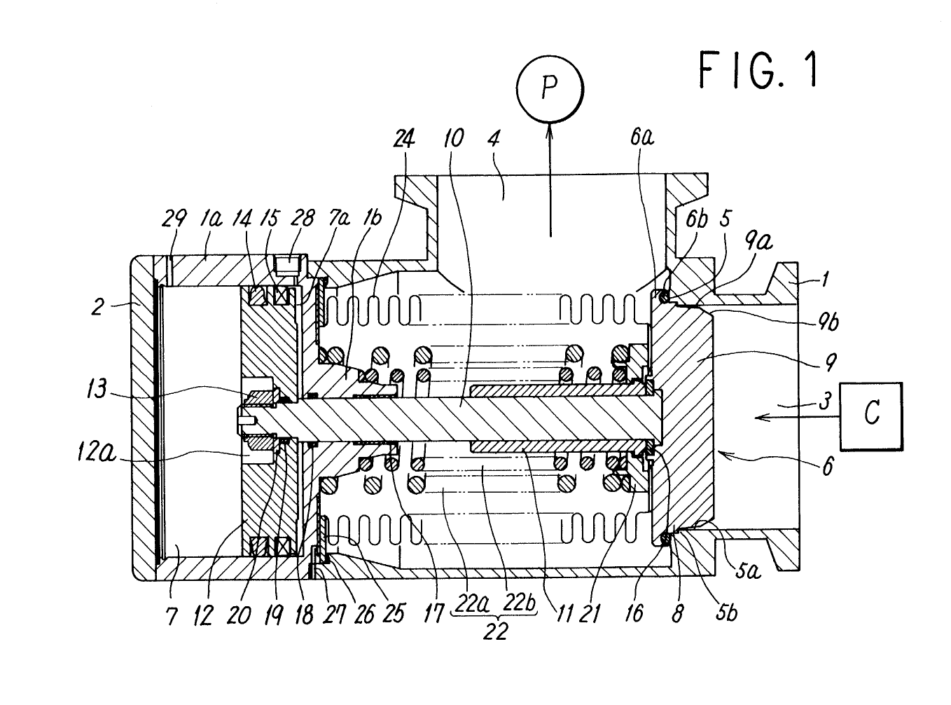

Embodiments of the present invention will be described below in detail based on the drawings. A vacuum exhaust valve shown in FIG. 1 has a substantially cylindrical casing 1. The casing 1 has a cylinder portion 1a connected to an axial rear end portion of the casing 1 and an opening end of the cylinder portion 1a is closed with a cover 2. A chamber port 3 to be connected to a vacuum chamber C is formed in a tip end portion of the casing 1 and a pump port 4 to be connected to a vacuum pump P is formed in a side face of the casing 1 in such a direction as to be orthogonal to an axis. In the casing 1, a valve seat 5 is formed in a flow path connecting the chamber port 3 and the pump port 4 and a valve mechanism for opening and closing the valve seat 5 is provided.

The valve mechanism has a valve body 6 for opening and closing the valve seat 5, a piston 12 actuated by operation of air pressure to drive the valve body 6, and a shaft 10 for connecting the valve body 6 and the piston 12 to each other.

The valve body 6 is formed of a disc-shaped valve holder 6a and a ring-shaped valve sealing member 6b mounted to a peripheral edge portion of the valve holder 6a and opens and closes the valve seat 5 in a poppet manner by bringing the valve sealing member 6b into contact with and separating the member 6b from the valve seat 5. The valve holder 6a is integrally provided with a locking portion 8 in a short columnar shape to be fitted in an inner hole 5a of the valve seat 5 and a flow rate adjusting portion 9 in a short columnar shape which is slightly longer in the axial direction than the locking portion 8. The locking portion 8 positioned on a base end portion side of the valve holder 6a has a uniform diameter, comes in contact with a stepped portion 5b on an inner periphery of the inner hole 5a in valve closing of the valve body 6 to thereby define a valve-closing position of the valve body 6. The flow rate adjusting portion 9 is provided in a position closer to a tip end portion of the valve body 6 than the locking portion 8 and formed into a gradually-tapered shape by having a plurality of tapered faces 9a, 9b with different gradients successively in an axial direction. By moving in the inner hole 5a as the valve sealing member 6b opens, the flow rate adjusting portion 9 functions to gradually increase a flow rate of air flowing through the flow path. When the valve body 6 has moved to an opening stroke end, the flow rate adjusting portion 9 occupies a position where the flow rate adjusting portion 9 has completely got out of the inner hole 5a of the valve seat 5.

A tip end portion of the shaft 10 is fitted in a central portion of the valve holder 6a and locked to the valve holder 6a by a shaft retainer 16 so as not to come out of the valve holder 6a. A rear end portion of the shaft 10 passes for sliding and airtightly through a central portion of a partition 1b for separating the casing 1 and the cylinder portion 1a from each other through a guide bushing 17 and a sealing member 18, projects into a piston chamber 7 formed in the cylinder portion 1a, and is airtightly connected by a fixing nut 13 to the piston 12 disposed for sliding in the piston chamber 7 through a retaining plate 20. This connection is carried out by screwing of the nut 13 in a recessed portion 12a formed in a back face of the piston 12.

The piston 12 has on an outer periphery thereof packing 14 and a guide ring 15 in airtight and sliding contact with an inner wall of the piston chamber 7 and a pressure operating chamber 7a defined between the piston 12 and the partition 1b communicates with an operating port 28 formed in a side wall of the cylinder portion 1a.

Therefore, if pressure air is supplied from the operating port 28 to the pressure operating chamber 7a, the piston 12 moves and the valve body 6 opens. In this case, pressure air with pressure controlled by an electropneumatic regulator is supplied to the operating port 28.

In the casing 1, spring means 22 formed of two coil springs 22a and 22b for repulsing the valve body 6 in a closing direction is provided between a spring seat 21 mounted to the valve holder 6a and the partition 1b and a bellows 24 in which the shaft 10 and the two springs 22a and 22b are enveloped is provided between a bellows holder 25 sandwiched between the casing 1 and the partition 1b and the valve holder 6a.

In the drawing, a reference numeral 11 designates a cylindrical spring guide fitted over an outer periphery of the shaft 10 to guide expansion and contraction of the spring means 22 while preventing the inner coil spring 22a from coming in contact with the shaft 10. A reference numeral 19 designates a sealing member for maintaining airtightness between the shaft 10 and the piston 12, a reference numeral 26 designates a sealing member for maintaining airtightness between the casing 1 and the bellows holder 25, a reference numeral 27 designates a breathing port for connecting inside space of the bellows 27 to an outside, and a reference numeral 29 designates a breathing port for connecting a breathing chamber behind the piston 12 to the outside.

In the vacuum exhaust valve having the above structure, in a non-operating state, the valve body 6 is moved to a closed position of the valve by a repulsing force of the spring means 22 and the valve sealing member 6b comes in contact with the valve seat 5 to thereby close the flow path. Therefore, if the vacuum pump P is operated in this state, gas in the vacuum chamber C is not discharged from the chamber port 3 into the pump port 4.

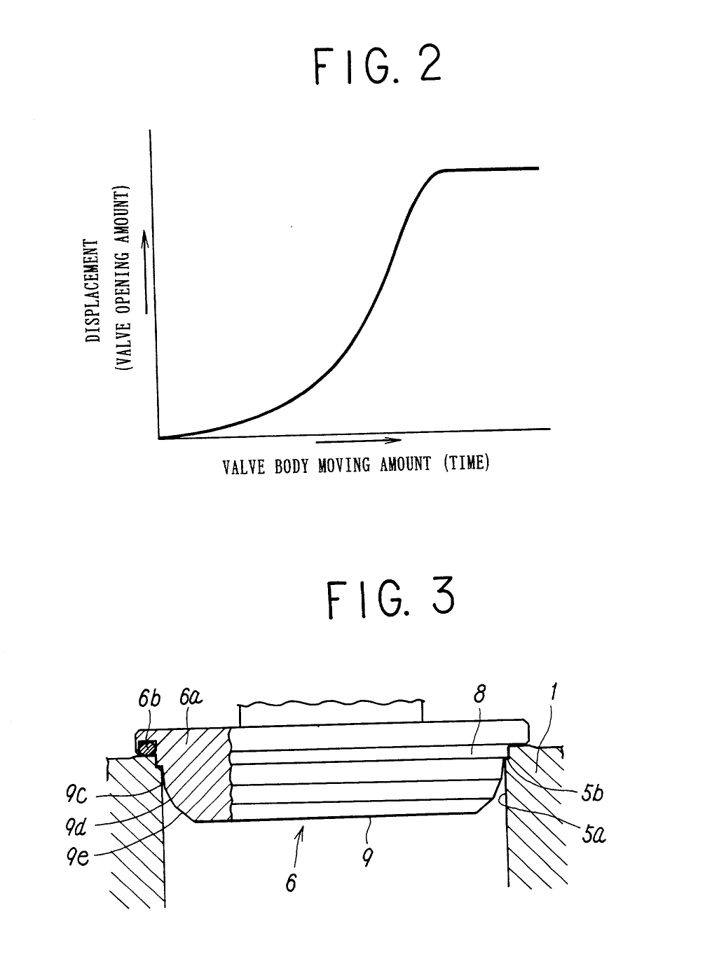

If pressure air with pressure controlled by the electropneumatic regulator (not shown) is supplied from the operating port 28 to the pressure operating chamber 7a and an air pressure operating force applied to the piston 12 exceeds the repulsing force of the spring means 22, the piston 12 moves to such a position as to come in contact with the cover 2 against the repulsing force of the spring means 22 and moves the valve body 6 through the shaft 10. Therefore, the valve sealing member 6b separates from the valve seat 5 to open the flow path and air in the vacuum chamber is exhausted. At this time, the flow rate adjusting portion 9 formed in the valve body 6 moves in the inner hole 5a in the valve seat 5 as the valve sealing member 6b opens the valve seat 5 and functions to gradually increase a flow rate of air with the gradually-tapered shape of the flow rate adjusting portion 9. Therefore, a rise of exhausting at an early stage of valve opening is made mild and the valve-opening amount is increased when exhausting has proceeded to some extent as shown in FIG. 2. As a result, rapid exhausting is not carried out at the early stage of exhausting when a large amount of air is still in the vacuum chamber C unlike prior art. Therefore, turbulence due to temporary flowing of a large amount of air is not generated and it is possible to reliably prevent raising of a cloud of particles deposited on a vacuum chamber inner wall or the like due to the turbulence, deposition of the particles on a wafer, and movement of the wafer or displacement of a set position of the wafer.

Vacuum pressure in the vacuum chamber C is detected by a sensor provided to the chamber port 3, to a piping portion connecting the chamber port 3 and the vacuum chamber C, or in the vacuum chamber C. In order to maintain or change the vacuum pressure in the vacuum chamber C at or to a set pressure, output pressure of the electropneumatic regulator is adjusted automatically.

If air pressure from the operating port 28 is reduced after a necessary degree of vacuum of the vacuum chamber C is obtained, the piston 12 and the valve body 6 return and the valve sealing member 6b comes in contact with the valve seat 5 to close the flow path when air pressure operating force applied to the piston 12 becomes smaller than the repulsing force of the spring means 22.

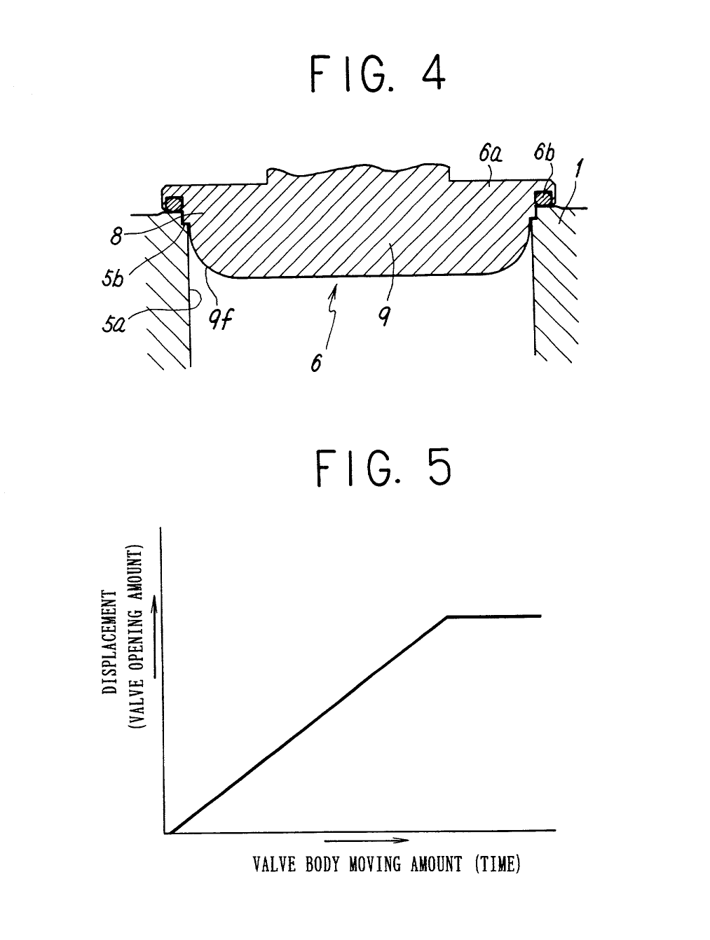

The vacuum exhaust valve of the invention is not limited to the structures of the above embodiments but various modifications in design can be made without departing from the spirit of the invention defined in claims. For example, as shown in FIG. 3, the flow rate adjusting portion 9 of the valve body 6 may include successive three tapered faces 9c, 9d, and 9e or may include four or more tapered faces. As shown in FIG. 4, the flow rate adjusting portion 9 may be formed into a tapered shape formed of a smooth curved face 9f instead of the above-described tapered faces.

As described above, in the vacuum exhaust valve of the invention, because the valve body includes the gradually-tapered pillar-shaped flow rate adjusting portion and the flow rate adjusting portion functions to gradually increase the flow rate of air flowing through the flow path in opening of the valve body, the rise of exhausting at the early stage of valve opening becomes mild. As a result, rapid exhausting is not carried out at the early stage of exhausting when a large amount of air is still in the vacuum chamber. Therefore, turbulence due to temporary flowing of a large amount of air is not generated and it is possible to reliably prevent raising of a cloud of particles deposited on a vacuum chamber inner wall or the like due to the turbulence, deposition of the particles on a wafer, and movement of the wafer or displacement of a set position of the wafer.

1. A vacuum exhaust valve comprising: a chamber port to be connected to a vacuum chamber and a pump port to be connected to a vacuum pump; a casing including said ports; a valve seat in a flow path connecting said chamber port and said pump port; a valve body for opening and closing said valve seat; a piston connected to said valve body through a shaft; a pressure operating chamber for applying air pressure in a valve-opening direction to said piston; and spring means for repulsing said valve body in a valve-closing direction,
wherein said valve body includes a valve sealing member for coming in contact with and separating from said valve seat to thereby open and close said valve seat in a poppet manner and a pillar-shaped flow rate adjusting portion to be fitted in an inner hole of said valve seat to move in said inner hole by opening and closing of said valve sealing member and said flow rate adjusting portion is formed in a gradually-tapered shape to thereby have a function of gradually increasing a flow rate of air flowing through said flow path in opening of said valve sealing member.

2. A vacuum exhaust valve according to claim 1, wherein said valve body includes a locking portion having a larger diameter than said flow rate adjusting portion in a position extending from said flow rate adjusting portion, a stepped portion with and to which said locking portion is to be fitted and locked is formed in said inner hole of said valve seat, and a valve-closing position of said valve body is defined by said locking portion and said stepped portion.

3. A vacuum exhaust valve according to claim 1, wherein said flow rate adjusting portion of said valve body has a plurality of tapered faces with different gradients successively in an axial direction.

4. A vacuum exhaust valve according to claim 1, wherein said flow rate adjusting portion of said valve body is formed of a smooth curved face in a gradually-tapered shape.
